(19) United States
(12) Patent Application Publication
(10) Pub. No.: US 2019/0330571 A1
(43) Pub. Date: Oct. 31, 2019

(54) SWELLABLE SILICA MICROPARTICLE

(71) Applicant: Conopco, Inc., d/b/a UNILEVER, Englewood Cliffs, NJ (US)

(72) Inventors: Irene Acouavie AMOUSSOU, Argenteuil (FR); Craig Warren JONES, Prenton, Wirral (GB); James MERRINGTON, West Kirby, Wirral (GB); Jane Elizabeth MUNRO-BROWN, Cheshire (GB)

(73) Assignee: Conopco, Inc., d/b/a UNILEVER, Englewood Cliffs, NJ (US)

(21) Appl. No.: 16/475,262

(22) PCT Filed: Jan. 2, 2018
(86) PCT No.: PCT/EP2018/050072

§ 371 Date: Jul. 1, 2019

(30) Foreign Application Priority Data
Jan. 10, 2017 (EP) 17150854.2

(51) Int. Cl. C11D 11/00; C11D 3/12; C11D 3/22; C11D 3/37; C11D 3/50

(52) U.S. Cl. CPC C11D 11/0088; C11D 3/124; C11D 11/0017; C11D 3/3719; C11D 3/505; C11D 3/222

(57) ABSTRACT

A swellable silica microparticle with a nonionic polysaccharide deposition aid attached to its outer surface. Also a composition containing from 0.01 to 6 wt % of the swellable silica microparticles and a benefit agent.

### TECHNICAL FIELD

This invention relates to swellable silica microparticles and their deposition onto a substrate.

### BACKGROUND

WO99/036470 discloses a polysaccharide conjugate comprising a polysaccharide selected from xyloglucans, glucomannans, mannans, galactomannans, Beta(1-3), (1-4) glucan and the xylan family incorporating glucurono, arabino and glucuronoarabinoxylan, which is chemically or physically attached to a particle carrying perfume, the polysaccharide conjugate being capable of binding to cellulose. The particle may be a range of materials including silica, in particular porous silica, organic polymer etc. The particles suitably have a diameter in the range 0.5 to 100 microns. Polysaccharide is conveniently attached to particles e.g. by absorption. For example, porous silica particles have surface properties that enable firm absorption of polysaccharide. Chemical attachment techniques may also be used. The cellulose binding capability of the polysaccharide provides a targeting function that finds particular applications, in targeting of particles containing perfume to bind to fabric. In a preferred embodiment the particles are porous and contain perfume in the pores. This embodiment involves filling the pores of the particles with the perfume and then blocking the pores with a coating of the polysaccharide so the perfume does not come out of the particle again easily. In the example porous silica was loaded with fragrance and then mixed with Locust bean gum (LBG). More perfume was apparently deposited onto cotton in the case of the LBG treated perfume loaded silica when compared to a non LBG treated control particle.

WO2012/022736 describes the attachment of a hydroxyl propyl cellulose (HPC) deposition aid to a particle by means of a process which was taught to be preferably a two-step process in which the first step forms a particle comprising the perfume and the second step applies a coating to the capsule which includes the HPC as a deposition aid. The first step can either be step-growth or addition polymerisation and the second step is preferably addition polymerisation. In the alternative a particle can be formed which does not contain the perfume but which is capable of adsorbing it at some later time. This particle is then decorated with the deposition aid thereby performing a two-step process analogous to that described above. The particle is subsequently exposed to the perfume which diffuses into the particle. Conveniently, this may be done in-product, for example by adding the particles with deposition aid to a partly or fully formulated product which contains the perfume. The perfume is then adsorbed by the particle and retained within the particle during use of the product, so that at least some of the perfume is released from the particles after the fabric treatment process, when the particles have become deposited on the fabric. Suitable classes of monomers for step-growth polymerization are given in the group consisting of the melamine/urea/formaldehyde class, the isocyanate/diol class (preferably the polyurethanes) and polyesters. Preferred are the melamine/urea formaldehyde class and the polyurethanes. Examples 6 and 8 used a technique whereby an outer melamine formaldehyde shell was formed from melamine formaldehyde pre-polymer to attach HPC to pre-formed melamine formaldehyde perfume encapsulates. Similar disclosure is made in Example 4 of WO2009/037060.

Consumers are becoming increasingly concerned about the presence of microplastics in their home and personal care products. Although perfume microcapsules are not the main focus of this concern the present inventors took the view that a responsible approach would be to investigate ways to reduce the level of microplastics discharged to waste from home and personal care products as a result of incorporation of perfume encapsulates.

As a result of their searches for alternative materials, some swellable silica materials were identified. These materials considerably reduce the amount of non-biodegradable organic matter associated with perfume delivery and have also been found to provide compatibility with alcohol (ethanol) based compositions. Hitherto the core shell perfume encapsulates used in the home and personal care fields have not been suitable for use in ethanolic compositions due to rapid leaching out of the perfume into the surrounding ethanolic liquid. These swellable silica materials are known for their ability to swell and absorb relatively large amount of non-polar material. It is also known that the process is reversible. We have found that a problem with trying to deliver perfume loaded into such particles is that the delivery efficiency is low due to the poor affinity of the swellable silica for the target substrate. Some will deposit through mechanical mechanisms but much higher deposition efficacies are desirable.

### SUMMARY OF THE INVENTION

According to a first aspect of the present invention there is provided a swellable silica microparticle with a non-ionic polysaccharide deposition aid attached to its outer surface.

Preferably, the swellable silica microparticle is a porous microparticle comprising sol-gel derived material, the sol-gel derived material including a plurality of alkylsiloxy substituents and wherein the sol-gel derived material is obtained from:
(a) at least one first alkoxysilane precursor having the formula:

(R′O)₃—Si—(CH₂)ₙ—Ar—(CH₂)ₘ—Si—(OR′)₃ (1)
where n and m are individually an integer from 1 to 8, Ar is a single-, fused-, or poly-aromatic ring, and each R′ is independently a C₁ to C₅ alkyl group and
(b) optionally, at least one second precursor having the formula:

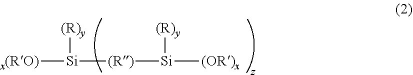

where x is 1, 2, 3 or 4; y is 0, 1, 2, 3; z is 0, 1; the total of x+y+z is 4; each R is independently an organic functional group; each an R′ is independently a C₁ to C₅ alkyl group and R″ is an organic bridging group, where the sol-gel derived material is swellable to at least 2.5 times its dry mass, when placed in excess acetone.

More preferably, the plurality of alkylsiloxy groups have the formula:

—(O)_{w}—Si—(R₃)_{4-w} (3)

where each R₃ is independently an organic functional group and w is an integer from 1 to 3.

The first alkoxysilane precursors of formula (1) may be selected from the group consisting of bis(trimethoxysilylethyl)benzene, 1,4-bis(trimethoxysilylmethyl)benzene and mixtures thereof.

The microparticles advantageously have a volume average diameter of 2 to 100 microns, preferably 10 to 80 microns.

It is preferred that the microparticle has the nonionic polysaccharide deposition polymer covalently bonded to it.

The deposition polymer is preferably a nonionic polysaccharide selected from the group consisting of mannan, glucan, glucomannan, xyloglucan, hydroxyalkyl cellulose, dextran, galactomannan and mixtures thereof, more preferably: xyloglucan, galactomannan, dextran and hydroxypropyl cellulose and most preferably xyloglucan or hydroxypropyl cellulose.

The nonionic polysaccharide preferably has a molecular weight Mw in excess of 40 kDa.

The deposition polymer levels may be from 0.1 to 10 wt %, based on microparticle weight.

Also according to the invention there is provided a composition containing from 0.01 to 6 wt % of microparticles according to the first aspect and a benefit agent.

The benefit agent is preferably perfume. Desirably at least 70 wt % of the perfume has a log Kow of greater than 2.8, and preferably at least 15 wt % has a log Kow greater than 4.

The composition may be a laundry treatment composition comprising:
i) at least 5 wt % amphiphilic material, preferably selected from the group consisting of detersive surfactants and quaternary ammonium compounds,
ii) from 0.1 to 5 wt % perfume,
iii) 0.2 to 5 wt % of the microparticles of the first aspect of the invention.

### DETAILED DESCRIPTION OF THE INVENTION

The Non-Ionic Polysaccharide

Preferred nonionic polysaccharide deposition polymers may be selected from the group consisting of: tamarind gum (preferably consisting of xyloglucan polymers), guar gum, locust bean gum (preferably consisting of galactomannan polymers), and other industrial gums and polymers, which include, but are not limited to, Tara, Fenugreek, Aloe, Chia, Flaxseed, Psyllium seed, quince seed, xanthan, gellan, welan, rhamsan, dextran, curdlan, pullulan, scleroglucan, schizophyllan, chitin, hydroxyalkyl cellulose, arabinan (preferably from sugar beets), de-branched arabinan (preferably from sugar beets), arabinoxylan (preferably from rye and wheat flour), galactan (preferably from lupin and potatoes), pectic galactan (preferably from potatoes), galactomannan (preferably from carob, and including both low and high viscosities), glucomannan, lichenan (preferably from icelandic moss), mannan (preferably from ivory nuts), pachyman, rhamnogalacturonan, acacia gum, agar, alginates, carrageenan, chitosan, clavan, hyaluronic acid, heparin, inulin, cellodextrins, cellulose, cellulose derivatives and mixtures thereof.

Non-hydrolysable nonionic polysaccharides are most preferred. The polysaccharide preferably has a ß-1,4-linked backbone. However, dextran which does not have such a backbone, is also preferred.

Preferably the polysaccharide is a cellulose, a cellulose derivative, or another ß-1,4-linked polysaccharide having an affinity for cellulose, preferably mannan, glucan, glucomannan, xyloglucan, galactomannan and mixtures thereof. More preferably, the polysaccharide is selected from the group consisting of xyloglucan and hydroxypropyl cellulose. Galactomannan is typically from Locust bean gum and/or guar.

A highly preferred nonionic polysaccharide is Hydroxypropyl Cellulose with a molecular weight in excess of 40 kDa. Hydroxypropyl Cellulose (HPC) has the repeat structure shown in generalised terms below:

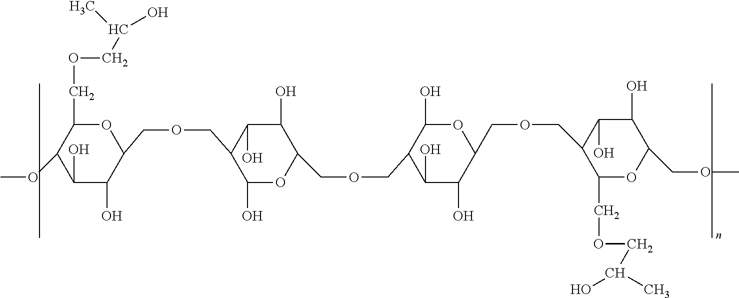

Especially good results may be obtained when the HPC is one with a viscosity in 2 wt % aqueous solution of 1000 to 4000 mPa·s. Viscosity measurements are done using a Brookfield viscometer, Spindle #3, @30 rpm. Lower viscosity materials are measured using Spindle #2, @60 rpm.

HPC is an ether of cellulose in which some of the hydroxyl groups in the repeating glucose units have been hydroxy-propylated forming —OCH₂CH(OH)CH₃ groups using propylene oxide. The average number of substituted hydroxyl groups per glucose unit is referred to as the degree of substitution (DS). Complete substitution would provide a DS of 3. However, as the hydroxy-propyl group itself contains a hydroxyl group, this can also be etherified during preparation of HPC. When this occurs, the number of moles of hydroxy-propyl groups per glucose ring, moles of substitution (MS), can be higher than 3.

The majority (typically around 75% for a DS of 3) of the mass of HPC is found in the substituent groups rather than the backbone.

Also, nonionic polysaccharides selected from the group consisting of: hydroxy-propyl methyl cellulose, hydroxy-ethyl methyl cellulose, hydroxy-propyl guar, hydroxy-ethyl ethyl cellulose and methyl cellulose may be used.

The ring spacing of these ß-1,4-linked polymers is such that each alternate ring of the polymer is well placed to allow a pseudo hydrogen-bond interaction with the pi-electron clouds of the phthalate rings in polyester. Moreover, these polymers have a balance of hydrophobicity and hydrophilicity which means that they are able to interact with a fabric without being so hydrophobic as to be insoluble. Other nonionic, modified polysaccharides, for example hydroxyl-ethyl cellulose, do not have the correct properties and show poor performance as deposition polymers, especially on polyester.

In those ethers of cellulosics in which some of the hydroxyl groups in the repeating glucose units have been hydroxy-alkylated the average number of substituted hydroxyl groups per glucose unit is referred to as the degree of substitution (DS). Complete substitution would provide a DS of 3. However, if the substituent group itself contains a hydroxyl group, this can also be etherified. When this occurs, the number of moles of substituent groups per glucose ring, moles of substitution (MS), can be higher than 3.

Some of the —OH groups (where present) in the hydroxyl-alkyl pendant group may be replaced with alkyl ethers. Typically these are C₁-C₂₀ alkyl ethers, and may, in specific cases be C₁₆-C₂₂ ethers. The most preferred alkyl chain is stearyl.

Hydroxy-propyl methyl cellulose (HPMC), has the repeat structure shown in generalised terms below:

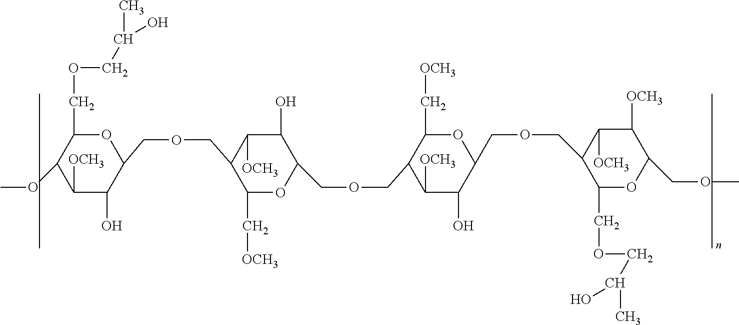

Since the hydroxypropoxy substituents can be attached to each other on side chains, the degree of substitution for HPMC can be higher than 3.

In useful derivatives of HPMC “Sangelose” some of the —OH groups in the hydroxyl-propyl pendant group are replaced with alkyl ethers. Typically these are C₁-C₂₀ alkyl ethers, and may, in specific cases be C₁₆-C₂₂ ethers. The most preferred alkyl chain is stearyl.

Hydroxy-ethyl methyl cellulose (HEMC), has the repeat structure shown in generalised terms below:

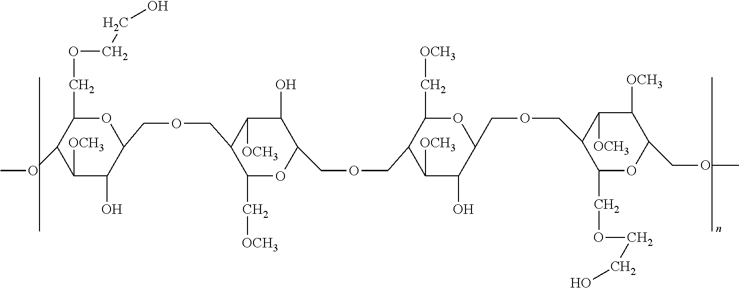

Since the ethoxy substituents can be attached to each other on side chains, the degree of substitution can be higher than 3.

Hydroxy-propyl guar (HPG), has the repeat structure shown in generalised terms below:

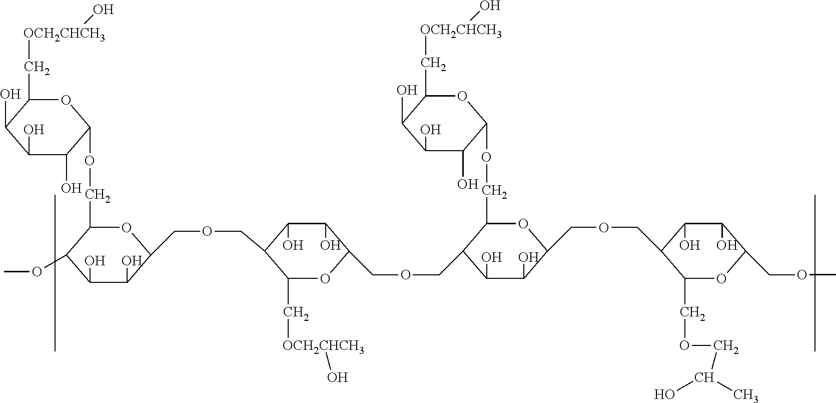

Since the hydroxypropoxy substituents can be attached to each other on side chains, the degree of substitution in HPG can be higher than 3.

Hydroxy-ethyl ethyl cellulose (HEEC), has the repeat structure shown in generalised terms below:

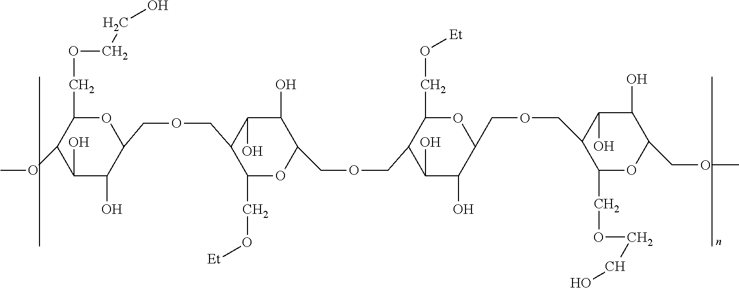

HEEC is less preferred than other nonionic polysaccharide delivery aids disclosed herein.

Methyl cellulose (ME), has the repeat structure shown in generalised terms below:

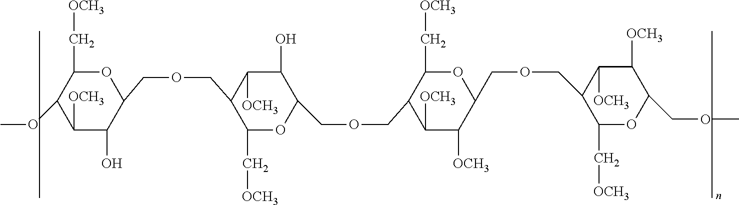

The theoretical maximum degree of substitution (DS) is 3.0. However, more typical values are 1.3 to 2.6.

Especially good results may be obtained when the deposition polymer is one which has a viscosity in 2 wt % aqueous solution of over 1000 mPa·s. Viscosity measurements are made using a Brookfield viscometer, Spindle #3, @30 rpm. Lower viscosity materials are measured using Spindle #2, @60 rpm.

Preferably the nonionic polysaccharide deposition polymer has a molecular weight above 50 kDa and more preferably above 140 kDa, most preferably above 500 kDa. As the molecular weight is increased the performance of the deposition polymer generally increases.

DS is typically in the range from 1.0 to 3, more preferably above 1.5 to 3, most preferably, where possible from 2.0 to 3.0.

A typical MS for the deposition polymer is 1.5 to 6.5. Preferably, the MS is in the range from 2.8 to 4.0, more preferably above 3.0, most preferably from 3.2 to 3.8.

Preferably, the deposition-aid polymer is present at levels such that the ratio, polymer:particle solids, is in the range 1:500 to 3:1, more preferably 1:500 to 1:2 and most, preferably 1:200 to 1:2.

The Swellable Silica Perfume Particle

A new type of organic inorganic hybrid sol gel microparticle is disclosed in U.S. Pat. No. 8,367,793B2 and US 201010096334A1 (ABS Materials), and P. Edmiston, Organic-Inorganic Hybrids, Chem. Mater. 2008, 20, 1312-1321.

Preferably, the microparticles have a volume average swollen diameter of 2 to 100 microns, more preferably 10 to 80 microns.

The silica sol gel microparticle having either a micro- or meso-porous structure. The microparticles advantageously have a microporous structure. These hybrid organic-inorganic materials comprise at least one type of organic bridging group that contains an aromatic segment that is flexibly linked to the alkoxysilane polymerisable ends. They differ from other silicas in that they have been described to be reversibly and potentially highly swellable by non-polar materials. We have shown that when added to a detergent liquid at a surprisingly high ratio with perfume it gives a controlled release of perfume that can provide the necessary release of perfume between the time that wet laundry is removed from the wash up to 24 hours to solve the early freshness moment problem.

Without wishing to be bound by theory it seems that the sol-gel derived microparticles can absorb a proportion of the total fragrance into the microparticle's 3-D network structure. Subsequently, because the absorption process is reversible, the fragrance is able to diffuse slowly from the particles to provide a reservoir to extend fragrance longevity from a surface to which a composition comprising the fragranced particles has been delivered. This effect does not need any external mechanism to be applied such as solvent pulsing as used previously to flush an active material back out of the microparticle after it has been absorbed.

Typical synthetic methods for the sol-gel derived microparticles can be found in Chem. Mater. 2008, 20, 1312-1321; and U.S. Pat. No. 8,367,793 B2.

Suitable silica sol gel derived microparticles are available as porous sol gel materials from by ABS Materials Inc., Wooster, Ohio under the tradenames of Osorb® or SilaFresh™. Osorb® media has a microporous morphology in the dry state whereas SilaFresh™ media has a mesoporous structure. Neither product adsorbs water. The sol-gels can further be derivatised with non-ionic deposition aids that are grafted by covalently bonding to the surface of the sol-gel using adaptations of methods previously disclosed and known to the skilled worker. The inclusion of deposition aids is particularly advantageous for delivery from laundry detergents and other perfumed products useful for treating laundry.

The sol-gel derived microparticle composition can be similar or identical to the swellable materials described in US2007/0112242 A1. For example, the sol-gel composition can include a plurality of flexibly tethered and interconnected organosilica particles having diameters on the nanometre scale. The plurality of interconnected organosilica particles can form a disorganized microporous array or matrix defined by a plurality of cross-linked aromatic siloxanes. The organosilica particles can have a multilayer configuration comprising a hydrophilic inner layer and a hydrophobic, aromatic-rich outer layer.

The sol-gel composition has the capability to swell to at least twice its dried volume when placed in contact with a fabric treatment liquid. Without being bound by theory, it is believed that swelling may be derived from the morphology of interconnected organosilica particles that are crosslinked during the gel state to yield a nanoporous material or polymeric matrix. Upon drying the gel and following a derivatization step, tensile forces may be generated by capillary-induced collapse of the polymeric matrix. Stored energy can be released as the matrix relaxes to an expanded state when elements of the fabric treatment compositions disrupt the inter-particle interactions holding the dried material in the collapsed state. New surface area and void volume may then be created, which serves to further capture additional liquid that can diffuse into the expanded pore structure. Initial adsorption to the surface of the composition occurs in the non-swollen state. Further adsorption may then trigger matrix expansion which leads to absorption across the composition-water boundary. Pore filling may lead to further percolation into the composition, followed by continued composition expansion to increase available void volume.

The porous sol-gel composition is obtained from at least one first alkoxysilane precursor having the formula:

(RO)₃—Si—(CH₂)ₙ—Ar—(CH₂)ₘ—Si—(OR)₃ (1)

where n and m are individually an integer from 1 to 8, Ar is a single-, fused-, or poly-aromatic ring, such as a phenyl or naphthyl ring, and each R is independently a C₁ to C₅ alkyl, such as methyl or ethyl.

Exemplary first alkoxysilane precursors include, without limitation, bis(trialkoxysilylalkyl)benzenes, such as 1,4-bis(trimethoxysilylmethyl)benzene (BTB), bis(triethoxysilylethyl)benzene (BTEB), and mixtures thereof, with bis(triethoxysilylethyl)benzene being preferred.

In another aspect, the porous sol-gel composition is obtained from a mixture of the at least one first alkoxysilane precursor and at least one second alkoxysilane precursor, where the at least one second alkoxysilane precursor has the formula:

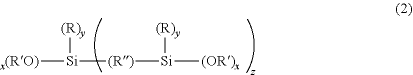

where x is 1, 2, 3 or 4; y is 0, 1, 2, 3; z is 0, 1; where the total of x+y+z is 4; R is independently an organic functional group; R′ is independently an alkyl group; and R″ is an organic bridging group, for example an alkyl or aromatic bridging group.

In one aspect, x is 2 or 3, y is 1 or 2 and z is 0 and R′ is a methyl, an ethyl, or a propyl group. In another aspect, R comprises an unsubstituted or substituted straight-chain hydrocarbon group, branched-chain hydrocarbon group, cyclic hydrocarbon group, or aromatic hydrocarbon group.

In some embodiments, each R is independently an aliphatic or non-aliphatic hydrocarbon containing up to about 30 carbons, with or without one or more hetero atoms (e.g., sulfur, oxygen, nitrogen, phosphorous, and halogen atoms) or hetero atom-containing moieties. Representative R′s include straight-chain hydrocarbons, branched-chain hydrocarbons, cyclic hydrocarbons, and aromatic hydrocarbons and are unsubstituted or substituted. In some aspects, R includes alkyl hydrocarbons, such as C₁-C₃ alkyls, and aromatic hydrocarbons, such as phenyl, and aromatic hydrocarbons substituted with heteroatom containing moieties, such —OH, —SH, —NH₂, and aromatic amines, such as pyridine.

Representative substituents for R include primary amines, such as aminopropyl, secondary amines, such as bis(triethoxysilylpropyl)amine, tertiary amines, thiols, such as mercaptopropyl, isocyanates, such as isocyanopropyl, carbamates, such as propylbenzylcarbamate, alcohols, alkenes, pyridine, halogens, halogenated hydrocarbons or combinations thereof.

Exemplary second alkoxysilane alkoxysilane precursors include, without limitation, tetramethoxysilane, methyltrimethoxysilane, methyltriethoxysilane, dimethyldimethoxysilane, dimethyldiethoxysilane, phenyltrimethoxysiliane, aminopropyl-trimethoxysilane, (4-ethylbenzyl)trimethoxysilane, 1,6-bis(trimethoxysilyl)hexane, 1,4-bis(triethoxysilyl)benzene, bis(triethoxysilylpropyl)amine, 3-cyanopropyltrimethoxysilane, 3-sulfoxypropyltrimethoxysilane, isocyanopropyltrimethoxysilane, 2-(3,4-epoxycyclohexyl)ethyltrimethoxysilane, and examples of suitable second precursors include, without limitation, dimethyldimethoxysilane, (4-ethylbenzyl)trimethoxysilane, 1,6-bis(trimethoxysilyl)hexane, 1,4-bis(trimethoxysilyl)benzene, tetramethoxysilane, methyltrimethoxysilane, methyltriethoxysilane, phenyltrimethoxysilane, with dimethyldimethoxysilane, (4-ethylbenzyl)trimethoxysilane, and phenyltrimethoxysilane being preferred.

Other examples of useful second precursors include, without limitation, para-trifluoromethylterafluorophenyltrimethoxysilane, (tridecafluoro-1,1,2,2-tetrahydro-octyl)trimethoxysilane; second precursors having a ligand containing —OH, —SH, —NH2 or aromatic nitrogen groups, such as 2-(trimethoxysilylethyl)pyridine, 3-aminopropyltrimethoxysilane, 3-mercaptopropyltrimethoxysilane, and second precursors with protected amine groups, such as trimethoxypropylbenzylcarbamate.

In one aspect, the second alkoxysilane precursor is dimethyldimethoxysilane, dimethyldiethoxysilane, phenyltrimethoxysilane or aminopropyltriethoxysilane.

The properties of the sol-gel derived composition can be modified by the second precursor. The second alkoxysilane precursor can be selected to produce sol-gel compositions having improved properties. In one aspect, the sol-gel derived compositions are substantially mesoporous. In one aspect, the sol-gel derived compositions contain less than about 20% micropores and, in one aspect, the sol-gel derived compositions contain less than about 10% micropores. In one aspect, the mesopores have a pore volume greater than 0.50 mL/g as measured by the BET/BJH method and in one aspect, the mesopores have a pore volume greater than 0.75 mL/gas measured by the BET/BJH method. In another aspect, the sol-gel derived composition generates a force upon swelling that is greater than about 200 N/g as measured by swelling with acetone in a confined system; in one aspect, the sol-gel derived composition generates a force upon swelling that is greater than about 400 N/g as measured by swelling with acetone in a confined system and in one aspect, the sol-gel derived composition generates a force upon swelling that is greater than about 700 N/g as measured by swelling with acetone in a confined system.

The sol-gel derived compositions may absorb at least 2.5 times the volume of acetone per mass of dry sol-gel derived composition. Examples of second precursors useful to effect the swellability of the sol-gel derived composition include dimethyldimethoxysilane, (4-ethylbenzyl)trimethoxysilane, 1,6-bis(trimethoxysilyl)hexane, 1,4-bis(trimethoxysilyl)benzene methyltrimethoxysilane, phenyltrimethoxysilane, with dimethyldimethoxysilane, (4-ethylbenzyl)trimethoxysilane, and phenyltrimethoxysilane being preferred.

The porous sol-gel compositions are obtained from an alkoxysilane precursor reaction medium, under acid or base sol-gel conditions, preferably base sol-gel conditions. In one aspect of the present invention, the alkoxysilane precursor reaction medium contains from about 100:00 vol:vol to about 10:90 vol:vol of the at least one first alkoxysilane precursor to the at least one second alkoxysilane precursor, in one aspect, and from about 20:80 vol:vol to about 50:50 vol:vol first alkoxysilane precursor to second alkoxysilane precursor. In one aspect, the alkoxysilane precursor reaction medium contains 100% of the at least one first alkoxysilane alkoxysilane precursor. The relative amounts of the at least one first alkoxysilane and the at least one second alkoxysilane alkoxysilane precursors in the reaction medium will depend on the particular alkoxysilane precursors and the particular application for the resulting sol-gel composition.

The reaction medium includes a solvent for the alkoxysilane precursors. In some aspects, the solvent has a Dimoth-Reichart solvatochromism parameter (E_{T}) between 170 to 205 kJ/mol. Suitable solvents include, without limitation, tetrahydrofuran (THF), acetone, dichloromethane/THF mixtures containing at least 15% by vol. THF, and THF/acetonitrile mixtures containing at least 50% by vol. THF. Of these exemplary solvents, THF is preferred. The alkoxysilane precursors are preferably present in the reaction medium at between about 0.25M and about 1M, more preferably between about 0.4M and about 0.8M, most preferably about 0.5 M.

A catalytic solution comprising a catalyst and water is rapidly added to the reaction medium to catalyze the hydrolysis and condensation of the alkoxysilane precursors, so that a sol gel coating is formed on the particles. Conditions for sol-gel reactions are well-known in the art and include the use of acid or base catalysts. Preferred conditions are those that use a base catalyst. Exemplary base catalysts include, without limitation, tetrabutyl ammonium fluoride (TBAF), fluoride salts, including but not limited to potassium fluoride, 1,5-diazabicyclo[4.3.0]non-5-ene (DBN), and alkylamines, including but not limited to propyl amines, of which TBAF is preferred.

As noted above, acid catalysts can be used to form sol-gel coatings, although acid catalysts are less preferred. Exemplary acid catalysts include, without limitation, any strong acid such as hydrochloric acid, phosphoric acid, sulfuric acid and the like.

In one aspect, water is present in the reaction medium at an amount so there is at least one half mole of water per mole of alkoxysilane groups in the alkoxysilane precursors. In one aspect, temperatures at polymerization can range from between the freezing point of the reaction medium up to the boiling point of the reaction medium. And in one aspect, the temperature range is from about 4° C. to about 50° C.

After gelation, the sol-gel coating is preferably aged for an amount of time suitable to induce syneresis, which is the shrinkage of the gel that accompanies solvent evaporation. The aging drives off much, but not necessarily all, of the solvent. While aging times vary depending upon the catalyst and solvent used to form the gel, aging is typically carried out for about 15 minutes up to about 10 days. In one aspect, aging is carried out for at least about 1 hour and, in one aspect, aging is carried out for about 2 to about 10 days. In one aspect, aging temperatures can range from between the freezing point of the solvent or solvent mixture up to the boiling point of the solvent or solvent mixture. And in one aspect, the aging temperature is from about 4° C. to about 50° C. And in some aspects, aging is carried out either in open atmosphere, under reduced pressure, in a container or oven.

After gelation and aging have been completed, the sol-gel composition is rinsed using an acidic solution, with solutions comprising stronger acids being more effective. In one aspect, the rinsing agent comprises concentrations between 0.009 to 0.2% w/v acid in an organic solvent. Representative organic solvents include solvents for the alkoxysilane precursors, including solvents having a Dimoth-Reichart solvatochromism parameter (ET) between 170 to 205 kJ/mol. Suitable solvents for use with the base catalysts include, without limitation, tetrahydrofuran (THF), acetone, dichloromethane/THF mixtures containing at least 15% by vol. THF, and THF/acetonitrile mixtures containing at least 50% by vol. THF. Preferred rinse reagents, include without limitation, 0.01% wt:vol HCl or 0.01% wt:vol H2SO4 in acetone. In one aspect, the sol-gel composition is rinsed with the acidic solution for at least 5 min. And in one aspect, the sol-gel composition is rinsed for a period of time from about 0.5 hr to about 12 hr.

An alternative rinsing method is to use a pseudo-solvent system, such as supercritical carbon dioxide.

After rinsing, the sol-gel derived material is characterized by the presence of residual silanols. In one aspect, the silanol groups are derivatized with a reagent in an amount sufficient to stoichiometrially react with the residual silanols and prevent cross-linking that might otherwise occur between the residual silanol groups. Suitable derivatization reagents include, without limitation, reagents that have both one or more silanol-reactive groups and one or more non-reactive alkyl groups. The derivatization process results in the end-capping of the silanol-terminated polymers present within the sol-gel derived material with alkylsiloxy groups having the formula:

—(O)_{w}—Si—(R₃)_{4-w} (3)

where each R₃ is independently an organic functional group as described above and w is an integer from 1 to 3.

One suitable class of derivatization reagents includes halosilanes, such as monohalosilane, dihalosilane and trihalosilane derivatization reagents that contain at least one halogen group and at least one alkyl group R₃, as described above. The halogen group can be any halogen, preferably Cl, F, I, or Br. Representative halosilanederivatization reagents include, without limitation, chlorosilanes, dichlorosilanes, fluorosilanes, difluorosilanes, bromosilanes, dibromosilanes, iodosilanes, and di-iodosilanes. Exemplary halosilanes suitable for use as derivatization reagents include, without limitation, cyanopropyldimethyl-chlorosilane, phenyldimethylchlorosilane, chloromethyldimethylchlorosilane, (trideca-fluoro-1,1,2,2-tetrahydro-octyl)dimethylchlorosilane, n-octyldimethylchlorosilane, and n-octadecyldimethylchlorosilane. And in one aspect, the halosilane derivatization reagent is trimethyl chlorosilane.

Another suitable class of derivatization reagents includes silazanes or disilazanes. Any silazane with at least one reactive group and at least one alkyl group R₃, as described above can be used. A preferred disilazane is hexamethyldisilazane.

The sol-gel derived composition is preferably rinsed in any of the rinsing agents described above to remove excess derivatization reagent, and then dried. Drying can be carried out under any suitable conditions, but preferably in an oven, e.g., for about 2 hours at about 60° C. to produce the porous, swellable, sol-gel derived composition.

In some aspects, the compositions contain a plurality of flexibly tethered and interconnected organosiloxane particles having diameters on the nanometer scale. The organosiloxane particles form a porous matrix defined by a plurality of aromatically cross-linked organosiloxanes that create a porous structure.

In some aspects, the resulting sol-gel compositions are hydrophobic, resistant to absorbing water, and absorb at least, 2.5 times, even at least five times and sometimes as much as at least ten times the volume of acetone per mass of dry sol-gel derived composition. Without being bound by theory, it is believed that swelling is derived from the morphology of interconnected organosilica particles that are cross-linked during the gel state to yield a porous material or polymeric matrix. Upon drying the gel, tensile forces are generated by capillary-induced collapse of the polymeric matrix. This stored energy can be released as the matrix relaxes to an expanded state when a sorbate disrupts the inter-particle interactions holding the dried material in the collapsed state.

In one aspect, the resulting sol-gel composition contains a plurality of flexibly tethered and interconnected organosiloxane particles having diameters on the nanometer scale. The organosiloxane particles form a porous matrix defined by a plurality of aromatically cross-linked organosiloxanes that create a porous structure. In some aspects, the resulting sol-gel composition has a pore volume of from about 0.9 mL/g to about 1.1 mL/g and, in some aspects, a pore volume of from about 0.2 mL/g to about 0.6 mL/g. In some aspects, the resulting sol-gel composition has a surface area of from about 50 m²/g to about 600 m²/g and, in some aspects, a surface area of from about 600 m²/g to about 1000 m²/g.

In one aspect, the resulting sol-gel composition is hydrophobic, resistant to absorbing water, and swellable to at least 2.5 times its dry mass, when placed in excess acetone, in one aspect, the sol-gel composition is swellable to at least five times its dry mass, when placed in excess acetone and, in one aspect, the sol-gel composition is swellable to at least ten times its dry mass, when placed in excess acetone.

The Perfume

Preferably at least 70 wt % of the perfume in the composition has a log K_{ow} of greater than 2.8, and more preferably at least 15 wt % has a log K_{ow} greater than 4.

The perfume suitably has a molecular weight of from 50 to 500. Where pro-fragrances are used the molecular weight will generally be higher.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA). These substances are well known to the person skilled in the art of perfuming, flavouring, and/or aromatizing consumer products, i.e., of imparting an odour and/or a flavour or taste to a consumer product traditionally perfumed or flavoured, or of modifying the odour and/or taste of said consumer product.

By perfume in this context is not only meant a fully formulated product fragrance, but also selected components of that fragrance, particularly those which are prone to loss, such as the so-called ‘top notes’. The perfume component could also be in the form of a pro-fragrance. WO 2002/038120 (P&G), for example, relates to photo-labile pro-fragrance conjugates which upon exposure to electromagnetic radiation are capable of releasing a fragrant species.

Top notes are defined by Poucher (Journal of the Society of Cosmetic Chemists 6(2):80 [1955]). Examples of well-known top-notes include citrus oils, linalool, linalyl acetate, lavender, dihydromyrcenol, rose oxide and cis-3-hexanol. Top notes typically comprise 15-25% wt of a perfume composition and in those embodiments of the invention which contain an increased level of top-notes it is envisaged at that least 20% wt would be present within the encapsulate.

Typical perfume components which it is advantageous to encapsulate, include those with a relatively low boiling point, preferably those with a boiling point of less than 300, preferably 100-250 Celsius.

It is also advantageous to encapsulate perfume components which have a low log K_{ow} (also called Log P) (i.e. those which will be partitioned into water), preferably with a Log P of less than 3.0. These materials, of relatively low boiling point and relatively low Log P have been called the “delayed blooming” perfume ingredients and include the following materials:

Allyl Caproate, Amyl Acetate, Amyl Propionate, Anisic Aldehyde, Anisole, Benzaldehyde, Benzyl Acetate, Benzyl Acetone, Benzyl Alcohol, Benzyl Formate, Benzyl Iso Valerate, Benzyl Propionate, Beta Gamma Hexenol, Camphor Gum, Laevo-Carvone, d-Carvone, Cinnamic Alcohol, Cinnamyl Formate, Cis-Jasmone, cis-3-Hexenyl Acetate, Cuminic Alcohol, Cyclel C, Dimethyl Benzyl Carbinol, Dimethyl Benzyl Carbinol Acetate, Ethyl Acetate, Ethyl Aceto Acetate, Ethyl Amyl Ketone, Ethyl Benzoate, Ethyl Butyrate, Ethyl Hexyl Ketone, Ethyl Phenyl Acetate, Eucalyptol, Eugenol, Fenchyl Acetate, Flor Acetate (tricyclo Decenyl Acetate), Frutene (tricycico Decenyl Propionate), Geraniol, Hexenol, Hexenyl Acetate, Hexyl Acetate, Hexyl Formate, Hydratropic Alcohol, Hydroxycitronellal, Indone, Isoamyl Alcohol, Iso Menthone, Isopulegyl Acetate, Isoquinolone, Ligustral, Linalool, Linalool Oxide, Linalyl Formate, Menthone, Menthyl Acetphenone, Methyl Amyl Ketone, Methyl Anthranilate, Methyl Benzoate, Methyl Benzyl Acetate,

Methyl Eugenol, Methyl Heptenone, Methyl Heptine Carbonate, Methyl Heptyl Ketone, Methyl Hexyl Ketone, Methyl Phenyl Carbinyl Acetate, Methyl Salicylate, Methyl-N-Methyl Anthranilate, Nerol, Octalactone, Octyl Alcohol, p-Cresol, p-Cresol Methyl Ether, p-Methoxy Acetophenone, p-Methyl Acetophenone, Phenoxy Ethanol, Phenyl Acetaldehyde, Phenyl Ethyl Acetate, Phenyl Ethyl Alcohol, Phenyl Ethyl Dimethyl Carbinol, Phenyl Acetate, Propyl Bornate, Pulegone, Rose Oxide, Safrole, 4-Terpinenol, Alpha-Terpinenol, and/or Viridine.

It is commonplace for a plurality of perfume components to be present in a formulation. In the encapsulates of the present invention it is envisaged that there will be four or more, preferably five or more, more preferably six or more or even seven or more different perfume components from the list given of delayed blooming perfumes given above present in the encapsulated perfume.

Part or all of the perfume may be in the form of a pro-fragrance. For the purposes of the present invention a pro-fragrance is any material which comprises a fragrance precursor that can be converted into a fragrance.

Suitable pro-fragrances are those that generate perfume components which are aldehydes. Aldehydes useful in perfumery include but are not limited to phenylacetaldehyde, p-methyl phenylacetaldehyde, p-isopropyl phenylacetaldehyde, methyinonyl acetaldehyde, phenylpropanal, 3-(4-t-butylphenyl)-2-methyl propanal, 3-(4-t-butylphenyl)-propanal, 3-(4-methoxyphenyl)-2-methylpropanal, 3-(4-isopropylphenyl)-2-methylpropanal, 3-(3, 4-methylenedioxyphenyl)-2-methyl propanal, 3-(4-ethylpheny)-2,2-dimethylpropanal, phenylbutanal, 3-methyl-5-phenylpentanal, hexanel, trans-2-hexenal, cis-hex-3-enal, heptanal, cis-4-heptenal, 2-ethyl-2-heptenal, 2,6-dimethyl-5-heptenal, 2,4-heptadienal, octanel, 2-octenal, 3,7-dimethyloctanal, 3,7-dimethyl-2,6-octadien-1-al, 3,7-dimethyl-1,6-octadien-3-al, 3,7-dimethyl-6-octenal, 3,7-dimethyl-7-hydroxyoctan-1-al, nonanal, 6-nonenal, 2,4-nonadienal, 2,6-nonadienal, decanal, 2-methyl decanal, 4-decenal, 9-decenal, 2,4-decadienal, undecanal, 2-methyldecanal, 2-methylundecanal, 2,6,10-trimethyl-9-undecenal, undec-10-enyl aldehyde, undec-8-enanal, dodecanal, tridecanal, tetradecanal, anisaldehyde, bourgenonal, cinnamic aldehyde, a-amylcinnam-aldehyde, a-hexyl cinnamaldehyde, methoxy-cinnamaldehyde, citronellal, hydroxy-citronellal, isocyclocitral, citronellyl oxyacet-aldehyde, cortexaldehyde, cumminic aldehyde, cyclamen aldehyde, florhydral, heliotropin, hydrotropic aldehyde, lilial, vanillin, ethyl vanillin, benzaldehyde, p-methyl benzaldehyde, 3,4-dimethoxybenzaldehyde, 3-and 4-(4-hydroxy-4-methyl-pentyl)-3-cyclohexene-1-carboxaldehyde, 2,4-dimethyl-3-cyclohexene-1-carboxaldehyde, 1-methyl-3-(4-methylpentyl)-3-cyclohexen-carboxaldehyde, p-methylphenoxyacetaldehyde, and mixtures thereof.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian. By means of the present invention these materials can be transferred to textile articles that will be worn or otherwise come into contact with the human body (such as handkerchiefs and bed-linen).

The perfume may be encapsulated alone or co-encapsulated with carrier materials, further deposition aids and/or fixatives. Preferred materials to be co-encapsulated in carrier particles with the perfume include waxes, paraffins, stabilizers and fixatives.

An optional yet preferred component of carrier particles is a formaldehyde scavenger. This is particularly advantageous in carrier particles which may comprise formaldehyde as a consequence of their manufacturing process or components. formaldehyde scavenger is chosen from: sodium bisulfite, urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), poly(vinyl amine), hexane diol, ethylenediamine-N,N′-bisacetoacetamide, N-(2-ethylhexyl)acetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, benzylamine, hydroxycitronellol, cyclohexanone, 2-butanone, pentane dione, dehydroacetic acid, chitosan, or a mixture thereof. Preferred formaldehyde scavengers are sodium bisulfite, ethyl acetoacetate, acetoacetamide, ethylenediamine-N,N′-bisacetoacetamide, ascorbic acid, 2,2-dimethyl-1,3-dioxan-4,6-dione, helional, triplal, lilial and mixtures thereof.

The Manufacturing Process

The process for the preparation of the particles may be a two-step process in which the first step forms a particle comprising the perfume and the second step applies a coating to the capsule which includes the deposition aid. For best results the deposition aid is added part way through the second step.

The first step can either be step-growth or addition polymerisation and the second step is preferably addition polymerisation.

In the alternative a particle can be formed which does not contain the perfume but which is capable of adsorbing it at some later time. This particle is then decorated with the deposition aid thereby performing a two-step process analogous to that described above. The particle is subsequently exposed to the perfume which diffuses into the particle. Conveniently, this may be done in-product, for example by adding the particles with deposition aid to a partly or fully formulated product which contains perfume. The perfume is then adsorbed by the particle and retained within the particle during use of the product, so that at least some of the perfume is released from the particles after the fabric treatment process, when the particles have become deposited on the fabric.

Suitable classes of monomers for step-growth polymerization are given in the group consisting of the melamine/urea/formaldehyde class, the isocyanate/diol class (preferably the polyurethanes) and polyesters. Preferred are the melamine/urea formaldehyde class, polyureas and polyurethanes.

Suitable classes of monomers for addition/free radical polymerization are given in the group consisting of olefins, ethylene, vinylaromatic monomers, esters of vinyl alcohol with mono- and di-carboxylic acids, esters of α,β-monoethylenically unsaturated mono- and dicarboxylic acids with alcohols, nitriles of α,β-monoethylenically unsaturated carboxylic acids, conjugated dienes, α,β-monoethylenically unsaturated monocarboxylic and dicarboxylic acids and their amides, methacrylic acid and its esters with alcohols and diols, acrylic acid and its esters with alcohols and diols, dimethyl or di-n-butyl maleate, and vinyl-sulfonic acid and its water-soluble salts, and mixtures thereof. The polymer particle may comprise mixtures of monomer units.

The polymer particle may optionally comprise monomers which are cross-linkers. Such cross-linkers may have at least two non-conjugated ethylenically unsaturated double bonds. Examples are alkylene glycol diacrylates and dimethacrylates. A further type of suitable cross-linking monomers are those that are conjugated, such as divinyl benzene. If present, these monomers constitute from 0.1 to 10% by weight, based on the total amount of monomers to be polymerised.

The monomers are preferably selected from: styrene; a-methylstyrene; o-chlorostyrene; vinyl acetate; vinyl propionate; vinyl n-butyrate; esters of acrylic, methacrylic, maleic, fumaric or itaconic acid with methyl, ethyl, n-butyl, isobutyl, n-hexyl and 2-ethylhexyl alcohol; 1,3-butadiene; 2,3 dimethyl butadiene; and isoprene. The preferred monomers are vinyl acetate and methyl acrylate.

Optionally, the monomers are used as co-monomers with one or more of acrylic acid, methacrylic acid, maleic acid, fumaric acid, itaconic acid, poly (alkylene oxide) monoacrylates and monomethacrylates, N-vinyl-pyrrolidone, methacrylic and acrylic acid, 2-hydroxyethyl acrylates and methacrylates, glycerol acrylates and methacrylates, poly(ethylene glycol) methacrylates and acrylates, n-vinyl pyrrolidone, acryloyl morpholine, vinyl formamide, n-vinyl acetamide and vinyl caprolactone, acrylonitrile (71 g/l), acrylamide, and methacrylamide at levels of less than 10% by weight of the monomer unit content of the particle; 2-(dimethylamino) ethyl methacrylate, 2-diethylamino) ethyl methacrylate, 2-(tert-butylamino) ethyl methacrylate, 2-aminoethyl methacrylate, 2-(2-oxo-1-imidazolidinyl) ethyl methacrylate, vinyl pyridine, vinyl carbazole, vinyl imidazole, vinyl aniline, and their cationic forms after treatment with alkyl halides.

Optional cross linkers include vinyltoluenes, divinyl benzene, ethylene glycol diacrylate, 1,2-propylene glycol diacrylate, 1,3-propylene glycol diacrylate, 1,3-butylene glycol diacrylate, 1,4-butylene glycol diacrylates, ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, divinylbenzene, vinyl methacrylate, vinyl acrylate, allyl methacrylate, allyl acrylate, diallyl maleate, diallyl fumarate, methylenebisacrylamide, cyclopentadienyl acrylate, and triallyl cyanurate.

It is preferable that the ratio of the monomers used in the overall shell formation and those used in deposition aid attachment are the ratio of 100:1 to 5:1 (as bulk shell former:deposition linker). Preferably, the ratio is 100:1-50:1.

As noted above the process for the preparation of the particles may be a two-step process in which the first step forms a capsule around the perfume and the second step applies a coating to the capsule which includes the deposition aid. The first step can either be step-growth or addition polymerization and the second step is preferably addition polymerization.

It is particularly preferably that the first step uses monomers selected from melamine/urea-formaldehyde or methyl-methacrylate or isocyanate/diol, and the second step uses monomers selected from vinyl acetate and/or methyl acrylate.

It is particularly preferred that the deposition aid is not added until the second step. For step-growth polymerization some heating is generally necessary to cause polymerization to proceed. Initiators and chain transfer agents may also be present in the polymerization mixture where use is made of any addition polymerization. Those skilled in the art will recognize that a chemical initiator will generally be required for addition polymerization but that there are instances in which alternative forms of initiation will be possible, e.g. ultrasonic initiation or initiation by irradiation.

The initiator is preferably a chemical or chemicals capable of forming free radicals. Typically, free radicals can be formed either by homolytic scission (i.e. homolysis) of a single bond or by single electron transfer to or from an ion or molecule (e.g. redox reactions). Suitably, in context of the invention, homolysis may be achieved by the application of heat (typically in the range of from 50 to 1000 C). Some examples of suitable initiators in this class are those possessing peroxide (—O—O—) or azo (—N═N—) groups, such as benzoyl peroxide, t-butyl peroxide, hydrogen peroxide, azobisisobutyronitrile and ammonium persulphate. Homolysis may also be achieved by the action of radiation (usually ultraviolet), in which case it is termed photolysis. Examples are the dissociation of 2,2′-azobis (2-cyanopropane) and the formation of free radicals from benzophenone and benzoin. Redox reactions can also be used to generate free radicals. In this case an oxidising agent is paired with a reducing agent which then undergo a redox reaction. Some examples of appropriate pairs in the context of the invention are ammonium persulphate/sodium metabisulphite, cumyl hydroperoxide/ferrous ion and hydrogen peroxide/ascorbic acid.

Preferred initiators are selected from the following:

Homolytic: benzoyl peroxide, t-butyl peroxide, hydrogen peroxide, azobisisobutyronitrile, ammonium persulphate, 2,2′-azobis (cyanopropane), benzophenone, benzoin, Redox: ammonium persulphate/sodium metabisulphite mixture, cumyl hydroperoxide/ferrous ion mixture and/or hydrogen peroxide/ascorbic acid mixture. Preferred initiators are ammonium persulphate and hydrogen peroxide/ascorbic acid mixture. The preferred level of initiator is in the range of from 0.1 to 5.0% w/w by weight of monomer, more preferably, the level is in the range of from 1.0 to 3.0% w/w by weight of monomer.

Chain transfer agents can optionally be used. A chain transfer agent contains very labile hydrogen atoms that are easily abstracted by a propagating polymer chain. This terminates the polymerization of the growing polymer, but generates a new reactive site on the chain transfer agent that can then proceed to initiate further polymerization of the remaining monomer. Chain transfer agents in the context of the invention typically contain thiol (mercaptan) functionality and can be represented by the general chemical formula RS—H, such as n-dodecyl mercaptan and 2-mercaptoethanol. Preferred chain transfer agents are monothioglycerol and n-dodecyl mercaptan, used at levels of, preferably from 0 to 5% w/w based on the weight of the monomer and more preferably at a level of 0.25% w/w based on the weight of the monomer.

The preferred product of such a process is a slurry or dispersion comprising some 30-50% of solids.

A particularly preferred process is one in which:
a) the swellable silica particles are formed, and,
b) a polymer layer is formed on the outer surface of the particles in the presence of the deposition aid.

Preferably the polymer is melamine/formaldehyde.

Whilst the invention is illustrated for use in laundry cleaning compositions the skilled person will be able to design and manufacture suitable enhanced deposition particles for other laundry applications such as softening or conditioning and even for hair shampoos and conditioners, floor cleaners, skin cleansers and other compositions where it is desirable to deliver perfume in the form of microparticles to a substrate.

The invention will now be further described with reference to the following non-limiting examples.

### EXAMPLES

### Example 1

### Synthesis of 2% XG-5% MF-Osorb® for Enhanced Deposition from Detergent

TABLE 1
Role of ingredients for making Osorb ® microparticles

| Ingredient | Role |
|---|---|
| Osorb ® - commercial silica | sorbent material |
| from ABS Materials | |
| SDS sodium dodecyl sulfate | stabiliser - ionic surfactant |
| Demineralized Water | Continuous phase |
| (to prepare beforehand) | |
| 1 wt % Xyloglucan solution [Glyloid 3S | deposition aid |
| (lot 10.12.20-3) MW = 880K] | |
| 5 wt % aqueous sodium carbonate Na₂CO₃ | alkaline solution |
| 10 wt % Formic acid | acidic solution |

Sample A: Preparation of Osorb® Microparticle Pre-Slurry 7 wt % -Osorb® with 1% Stabiliser

SDS (0.475 g) and demineralized water (38.921 g) was added to a 60 mL glass jar (see Table 1). The mixture was stirred for 30 minutes at ambient temperature on a magnetic stirrer with flea. After 30 minutes, 2.85 g Osorb® silica (<400 mesh) was added and stirring was continued for a further 15 minutes. The mixture was then placed on a high shear mixer (Ultra-Turrax IKA T10) for 120 sec at 20,000 rpm. It was then left to stir overnight on a magnetic multi-stirrer plate.

Sample B: Preparation of 1 wt % XG Solution

Sample B was a 1 wt % Xyloglucan (XG) solution made of Glyloid 3S (MW=880K). 1 g Xyloglucan was dissolved in 99 g of demineralized water. The dispersion was homogenised at 8,000 rpm in boiling distilled water for 5 minutes, with an Ultra-Turrax IKA T25.

Sample C: MF Prepolymer Synthesis

Sample C was a Melamine-Formaldehyde prepolymer used as a pre-cursor for the grafting of XG to the OSorb® particle.

To a 100 mL conical flask was added 19.5 g formalin (37 wt % aqueous formaldehyde) and 44 g water. The pH of the solution was adjusted to 8.9 using 5 wt % aqueous sodium carbonate. 10 g of melamine and 0.64 g of sodium chloride were added and the mixture stirred for 10 minutes at room temperature. The mixture was heated to 62° C. and stirred until it became clear. (Total=74.14 g). The pre-polymer C consisted of 23.2 wt % of trimethyloyl melamine in water.

Grafting Method

7 g XG solution (Sample B) was added to the Osorb® particle mixture (Sample A). The mixture was heated in a reaction flask using a Tornado™ overhead stirring system at 200 rpm, at 75° C.

0.754 g MF pre-polymer solution was added to the Osorb® encaps with XG mix (Sample A) and stirred.

For the control sample, which did not contain an MF secondary shell or have any XG grafted the above process was also carried out.

For both samples, the pH was adjusted to 4 using 10 wt % Formic Acid solution. The reaction vessels were then sealed and heated and stirred for 3 hours. Finally, the vessels were cooled and the pH adjusted to 7 using 5 wt % Na₂CO₃ solution.

### Example 2

### Turbidity Measurement for Deposition Efficacy

The Osorb® slurry was added to the laundry detergent composition, as detailed in Table 2. Then the mixture was left on laboratory rollers to equilibrate for 48 h prior to testing.

TABLE 2
Structured Laundry Liquid Detergent

| System name | Ingredients | % Required | % Activity |
|---|---|---|---|
| Structured | Demineralised Water | | |
| Detergent | DB-310 Antifoam | 0.001 | 31 |
| 4:3:3 Non-bio | Structuring polymer | 0.15 | 80 |
| pH 7.0 +/− 0.3 | Mill at 1.2 kJ/kg | | |
| | Glycerol | 2.00 | 100 |
| | Neodol 25-7 | 4.365 | 100 |
| | Polyacrylate polymer | 0.40 | 30 |
| | TEA | 8.82 | 99 |
| | LAS Acid | 5.82 | 97 |
| | Fatty acid | 0.86 | 100 |
| | Dequest 2010 | 1.50 | 60 |
| | Citric Acid | 1.00 | 50 |
| | SLES 3EO | 4.37 | 70 |
| | BIT | 0.04 | 20 |
| | 10% Hole | 10.00 | 100 |
| | Mill at 2.8 kJ/kg | | |

TABLE 3
Model Powder wash composition

| | | | | % |
|---|---|---|---|---|
| System name | Ingredient | | Quantity g | Activity |
| 10 x Surfactant | LAS | Linear alkyl benzene | 9.41 | 90 |
| stock | granules | sulphonate | | |
| | NI | Neodol 25-7 | 0.847 | 100 |
| | | (Non-Ionic) | | |
| | Water | Demineralised water | 989.74 | 100 |
| Buffer Stock | Na₂CO₃ | Sodium carbonate | 75.46 | 100 |
| 10 × stock 1M | NaHCO₃ | Sodium bicarbonate | 24.19 | 100 |
| | Water | Demineralised water | 900.35 | 100 |
| 10 x Sulphate | Na₂SO₄ | Sodium sulphate | 22.89 | 100 |
| stock | Water | Demineralised water | 977.10 | 100 |

The deposition efficacy measurement was performed with a Rotawash device laboratory set to simulate a washing machine cycle. It used a single rotation speed of 40 rpm. The set-up comprised 12 steel wash pots placed on 4 rows of 3 pots in a 20 L stainless steel tank. Those wash pots with a 500 mL capacity had rubber seals to prevent liquid leaking from the pot. The pots were fixed on a rotating horizontal frame driven by a motor, which moved the wash liquor in the metal container with a movement that mimicked the mechanical motion of wash load and wash liquor during a washing procedure. Thermostatically controlled tubular heating elements heated the water bath to the set temperature of 40° C. The water used for the deposition studies was 26° FH For each test, each sample was tested with repeats. (4 samples with 3 identical pots each samples e.g.: 1A, 1B, 1C, 2A, 2B, 2C, 3A . . . ).

Two types of wash liquor were used: either with the detergent mentioned in Table 2 or a model laundry powder (Table 3). The Osorb® and Osorb®-MF-Xg samples were at a concentration of 500 ppm.

### Example 3

### Deposition from Laundry Liquid Detergent and European Powder Model Wash

In each metal pot was added 70 mL water and 30 mL of 10 wt % EU Model wash solution followed by 0.720 mg of either Osorb® slurry or Osorb®-MF-Xg slurry and mixed for five minutes.

For this test, half of the pots were filled with either with the laundry liquid base detergent and the other half with Model Wash powder.

A 5 mL sample of each wash liquor was taken as an initial reference measurement for later analysis of deposition on fabric.

Then, a 20 cm by 20 cm section of unfluoresced woven cotton cloth was placed in each metal pot containing the wash liquor and Osorb® particles at 500 ppm. The pots were rotated for 45 minutes at 40° C. to simulate the main wash cycle.

A 5 mL sample of the remaining wash liquor was taken for later measurements. The cloths were removed from each pot and wrung by hand.

After all the pots had been rinsed thoroughly, the wrung cloths were returned to their allocated pot and 100 mL of 26° FH water was added. The metal pots were placed back on the water bath and rotated for an additional 10 minutes at 40° C. to simulate the rinse cycle.

A 5 mL sample of the remaining rinse solution was then taken for absorbance measurements. Cloths were removed from each pot and wrung by hand. Then they were dried for 24 hours on a drying rack at ambient temperature.

Analysis: Deposition via Turbidity

In total, three samples from each pot were collected: before the wash (Initial sample), after the wash (Wash sample) and after the rinse (Rinse sample).

Deposition on fabric was assessed via turbidity measurements with a Hewlett Packard HP 8453 Diode Array UV/Vis Spectrophotometer and an Agilent ChemStation software for UV-Vis spectroscopy.

The HP 8453 spectrophotometer is a single-beam, microprocessor-controlled, UV-visible spectrophotometer with collimating optics. This device uses a photodiode array for simultaneous measurement of the complete ultra-violet to visible light spectrum in less than one second.

Measurements are made of absorbance via UV-vis spectrometer using a 1 cm cuvette. For this study, samples to analyse were placed in 4.5 mL Kertell PMMA cuvettes with two clear sides.

The concentration of the Osorb® particles remaining in the wash liquor after the wash was determined and therefore the level of deposition on the cloth during the wash cycle was determined by difference from the initial reference.

In the same way, the concentration of Osorb® particles removed from the cloth during the rinse stage was determined. The percentage loss of Osorb® particles from the cloths were determined by comparison with the amount deposited during the wash stage.

Table 4 illustrates the results from both the liquid detergent measurements, and the model powder wash.

TABLE 4
Deposition Results of Osorb ® v Osorb ®-MF-Xg

| Detergent | | Deposition During | Retained Particles |
|---|---|---|---|
| Type | Particle Used | Wash % | on Cloth after Rinse |
| Liquid | Osorb ® (no | 20 | <5 |
| | deposition aid) | | |
| Liquid | OSorb ®-MF-XG | 82 | 60 |
| Powder | Osorb ® (no | 60 | 36 |
| | deposition aid) | | |
| Powder | OSorb ®-MF-XG | 83 | 63 |

Deposition via SEM-EDS (Si Detection on Fabric)

Scanning Electron Microscopy (SEM) with Energy Dispersive X-ray Spectroscopy (EDS) was also used to provide evidence of deposition onto the woven cotton. The dried cloths from above from the model wash tests (Osorb®, and Osorb®-MF-Xg) were semi quantified for Silicon (Si) concentration using the following method.

Elemental analysis was carried out using a Hitachi S-3400N SEM (Scanning Electron Microscope) fitted with an Oxford Instruments X-Max EDS detector and analysed using Aztec EDS software. The SEM was used in variable pressure mode (50 Pa), instrument conditions were accelerating voltage 10 kV, 55 probe and working distance 10 mm and the sample was uncoated.

For each sample 3 pieces of cloth from different pot washes were analysed. Four 1 cm² samples of fabric were randomly cut from each cloth and mounted using a carbon sticky tab onto a 15 mm Aluminium stub. EDS spectra (area scan mode) were collected from 6 randomly selected areas on the fabric at 100×magnification (equating to approx. 1000 μm×1300 μm per analysis). Data from 24 spectra per cloth i.e. 72 spectra per sample were analysed. For each analysis, the semi quantitative concentration of silicon was recorded. The semi-quantitative concentration Si results for each cloth was averaged to yield an average Si level for each of the 3 cloths per treatment and were used in the subsequent analysis to calculate the average semi-quantitative concentration Si per treatment with 95% confidence intervals calculated using the standard student-t method. Table 5 gives the results.

TABLE 5
Semi-quantitative Deposition Data via SEM-EDS

| | | Std. Dev. | | Std. Error | |
|---|---|---|---|---|---|
| | Mean semi- | Semi- | | semi- | |
| | quantitative | quantitative | | quantitative | |
| | concen- | concen- | | concen- | 95% |
| | tration | tration | | tration | confidence |
| Test Cloth | Si | Si | n | Si | interval |
| Osorb ®- | 0.909 | 0.146 | 3 | 0.084 | 0.363 |
| 5% MF- | | | | | |
| 2% XG | | | | | |
| Osorb ® (no | 0.274 | 0.107 | 3 | 0.062 | 0.267 |
| deposition | | | | | |
| aid) | | | | | |

### Example 4

### Effect of Deposition Aid on Perfume Absorption

To check that the perfume absorbing capacity of the swellable silica Osorb® microparticles was not compromised by addition of the nonionic polysaccharide deposition aid comparative tests were performed.

Method for the Assessment of Effect of MF-Xq Coating on Oil Uptake into Osorb®. p The objective of this example was to investigate if the modification of Osorb® media with a melamine-formaldehyde (MF)-xyloglucan (Xg) coating, as described in Example 1 affected the absorption of oils from dilute surfactant solution.

Test Materials:
1. Osorb® media, dispersed in water using sodium dodecyl sulphate (SDS) (Samples A; 6% Osorb®, 1% SDS).
2. MF-Xg coated Osorb® media, dispersed in water using SDS (Samples B; 6% Osorb®, 0.3% MF, 0.12% Xg, 1% SDS).

Stock Solutions:
1. 1 g of SDS mixed with 99 g of demin water and rolled for 1 hour.
2. 3 mg of Hostasol 3 G mixed with 30 g of isopropyl myristate (IPM) using an Ultraturrax at 8000 rpm for 5 minutes.

Method:

1.5 g of either coated or uncoated Osorb® media slurry was added to a 2 mL Eppendorf tube, followed by a varied volume of IPM solution (see Table 6).

TABLE 6

| | | IPM (oil) level, as % of | |
|---|---|---|---|
| Test | Sample | Osorb ® | IPM solution, g |
| 1 | Osorb ® (A) | 50% | 0.045 |
| 2 | Osorb ® (A) | 100% | 0.09 |
| 3 | Osorb ® (A) | 200% | 0.18 |
| 4 | Osorb ®-MF-Xg (B) | 50% | 0.045 |
| 5 | Osorb ®-MF-Xg (B) | 100% | 0.09 |
| 6 | Osorb ®-MF-Xg (B) | 200% | 0.18 |

Mixtures were inverted for 1 hour and rolled overnight, before being centrifuged at 11,000 rpm for 10 minutes splitting samples into clear surfactant-phases and opaque particle-phases.

0.5 mL of each clear surfactant phase was removed, filtered through a 0.45 μm PTFE filter and diluted by a factor of 3 using 1% SDS solution. 100 μL of these solutions were transferred to wells in a black-walled microtitre plate.

The fluorescence of each solution was assessed using fluorescence spectroscopy (VarioSkan Lux, ex. 460 nm; em. 510 nm).

The results are shown in Table 7. IPM solution level is expressed as a wt % of Osorb® present.

TABLE 7

| Sample | Fluorescence Units | Fluorescence Units, minus blank |
|---|---|---|
| 1 | 0.06426 | 0.00426 |
| 2 | 0.09948 | 0.03948 |
| 3 | 0.6873 | 0.62730 |
| 4 | 0.08567 | 0.02567 |
| 5 | 0.09383 | 0.03383 |
| 6 | 0.1171 | 0.05710 |
| Blank | 0.05975 | 0.00000 |

At 50% and 100% oil loading we see highly effective absorption of fluorescer for both coated and uncoated materials. This suggests that the oil is also absorbed in a similar fashion.

At 200% oil loading the level of fluorescer absorbed appears to be dependent of whether the coating is present or not, with higher level of fluorescer absorption associated with the coated materials.

Based on this information, there is no reason to believe that the modification of Osorb® to have a deposition polymer on its surface reduces the uptake of oil.

1. A swellable silica microparticle with a covalently bonded nonionic polysaccharide deposition polymer attached to its outer surface; wherein the nonionic polysaccharide deposition polymer is a nonionic polysaccharide selected from the group consisting of mannan, glucan, glucomannan, xyloglucan, hydroxyalkyl cellulose, dextran, galactomannan and mixtures thereof; wherein the swellable silica microparticle is a porous microparticle comprising sol-gel derived material, the sol-gel derived material including a plurality of alkylsiloxy substituents and wherein the sol-gel derived material is obtained from:
(a) at least one first alkoxysilane precursor having the formula:
(R′O)₃—Si—(CH₂)ₙ—Ar—(CH₂)ₘ—Si—(OR′)₃ (1)
where n and m are individually an integer from 1 to 8, Ar is a single-, fused-, or poly-aromatic ring, and each R′ is independently a C₁ to C₅ alkyl group and
(b) optionally, at least one second precursor having the formula: 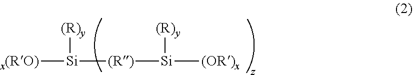
where x is 1, 2, 3 or 4; y is 0, 1, 2, 3; z is 0, 1; the total of x+y+z is 4; each R is independently an organic functional group; each an R′ is independently a C₁ to C₅ alkyl group and R″ is an organic bridging group, where the sol-gel derived material is swellable to at least 2.5 times its dry mass, when placed in excess acetone;
in which the swellable silica microparticles are obtainable by a process in which:
a) the swellable silica particles are formed, and,
b) a melamine-formaldehyde polymer layer is formed on the outer surface of the particles in the presence of the deposition aid.

2. A microparticle according to claim 1 wherein the plurality of alkylsiloxy groups have the formula:
—(O)_{w}—Si—(R₃)_{4-w} (3)
where each R₃ is independently an organic functional group and w is an integer from 1 to 3.

3. The microparticle according to claim 1 wherein the first alkoxysilane precursors of formula (1) are selected from the group consisting of bis(trimethoxysilylethyl)benzene, 1,4-bis(trimethoxysilylmethyl)benzene and mixtures thereof.

4. The microparticle according to claim 1 wherein the microparticles have a volume average diameter of 2 to 100 microns, preferably 10 to 80 microns.

5. The microparticle according to claim 1 wherein the deposition polymer is selected from the group consisting of xyloglucan, galactomannan, dextran and hydroxypropyl cellulose.

6. The microparticle according to claim 1 wherein in which the deposition polymer is xyloglucan or hydroxypropyl cellulose.

7. The microparticle according to claim 1 in which the nonionic polysaccharide has a molecular weight Mw in excess of 40 kDa.

8. The microparticle according to claim 1 in which the deposition polymer levels are from 0.1 to 10 wt %, based on microparticle weight.

9. The composition containing from 0.01 to 6 wt % of microparticles according to claim 1 and a benefit agent.

10. The composition according to claim 9 wherein the benefit agent is perfume.

11. The composition according to claim 10 wherein at least 70 wt % of the perfume has a log K_{ow} of greater than 2.8, and preferably at least 15 wt % has a log K_{ow}greater than 4.

12. A laundry treatment composition comprising:
i) at least 5 wt % amphiphilic material selected from the group consisting of detersive surfactants and quaternary ammonium compounds,
ii) from 0.1 to 5 wt % perfume; and
iii) 0.01 to 6 wt % swellable microparticles.
